(19) United States
(12) Patent Application Publication
(10) Pub. No.: US 2010/0051603 A1
(43) Pub. Date: Mar. 4, 2010

(54) EGG COOKING UTENSIL

(76) Inventor: Brian Powell, Shropshire (GB)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/515,840

(22) PCT Filed: Nov. 21, 2007
(86) PCT No.: PCT/GB2007/004458

§ 371 Date: May 21, 2009

(30) Foreign Application Priority Data
Nov. 21, 2006 (GB) 0623155.9
Nov. 20, 2007 (GB) 0723051.9

(51) Int. Cl. A47J 29/00; H05B 3/68

(52) U.S. Cl. 219/448.11; 219/450.1

(57) ABSTRACT

A utensil for cooking eggs without shells which has separate egg cooking and steam generation zones, a lid and direct heat in co-ordination with controls so that at least one cooking cycle can be repeated.

This invention related to cooking eggs without shells.

### BACKGROUND

This invention solves the problems of cooking eggs by frying or poaching.

When frying an egg one needs quite a lot of oil, some skill to cook an egg of consistent quality, i.e. with no burnt parts, or with a soft yoke but still with all the white cooked. When one requires an egg “over easy” as in America this is to get all the white cooked whilst still keeping a soft yoke. This requires a skillet or same and it is very easy to break the yoke.

With poaching in water, the water must first be heated to the correct temperature. This takes time, and even more skill is required to cook correctly. Often the egg breaks up in the water.

By using a traditional egg poaching pan, one has to test the eggs several times, and inevitably some white is left uncooked. This method always takes the longest time. A boiled egg takes about 3-5 minutes. Currently egg cooking equipment exists for cafes whereby both bottom and top lids are electrically heated. These are heavy, expensive, cumbersome and energy inefficient. The eggs are cooked in “old” fat and the eggs often get “brown burn pieces” on them. The eggs can be consistently cooked only by a trained and experience cook, they can easily be under or overcooked, or of inconsistent shape.

### Previous Patents

Frying and basting with steam is not new, examples as early as 1950 have been found. However our testing and development has clearly shown the inadequacies of previous designs.

This patent provides an improvement to and co-ordinates the cooking methods described in patent GB2417669. In particular to the heating and the controls which replicate the cooking cycle so that even a person with no knowledge can use the equipment.

Note! This patent starts to describe an electronic control system that will be fully described in a new future patent.

Our development process has been targeted at the needs of two user groups—home users and catering users.

For home users, features such as cost, easy of use, size are most important.

For catering users, features such as performance, speed, cleaning, service and serving to the plate are important.

### DESCRIPTION OF INVENTION

An egg cooking utensil for cooking eggs without shells that uses direct heat and steam in co-ordination to cook eggs quickly, economically, and consistently.

The invention has separate egg cooking and steam generation zones or plates.

These are heated with integrated heat coils or thick film or induction or the like.

A close fitting lid covers at least one steam and egg area. A small quantity of water is boiled on the steam zone which expands into the void made between the steam and egg areas and the outer raised section, heating it and the void up quickly.

Controls allow for at least one programmed (replicated) cooking cycle but capable of different cooking programmes such as poach or fry.

A simple cooking cycle is controlled by a bi-metal switch which together with a designed plate mass and power input offers an expected egg heat up curve or map. Adjusting the bi-metal switch, heat mass and power input affects the heat up curve which can be used to model an expected cook cycle (how the operator cooks the egg).

Loading the egg into the egg cooking plate causes a temperature drop.

By using electronic controls the energy input can be dynamic (change during the cook cycle), it can also hold more than one programmed cook cycle. This not only allows for multiple cook modes but allows for a quicker cook cycle.

More sophisticated controls are described in a future patent.

### Advantages

Our design uses a cooking plate with little mass and direct heat or integrated heating elements. This allows quick heat up and low energy usage. Each egg can be cooked in its own plate and this keeps the size more constant and allows the quality to be increased, the eggs always look the same for any cooking cycle.

Bi-metal or electronic controls combined with the low plate mass allows for quick responses to temperature increases this allows replication of a cooking cycle. The temperature drop when an egg is loaded is the fundamental feature to start of the cook cycle and hence a reproducible egg.

Water and eggs are kept separate. This allows the egg to steam and not get mixed with water which produces a partially or badly cooked egg.

The void under the lid is small so that little water is used, in fact only about 1 teaspoon is needed, the void and lid heat up quickly and the water is completely boiled away during the cooking cycle, therefore the cooking operation is inherently safe.

Our testing with different lids, metal, glass, plastic etc as proven that by keeping the temperature under the lid high, water does not condense and drop onto the egg or plate, which if occurring on a fry cycle will make hot oil splatter. Water condensing onto the eggs produces small craters as the egg is cooking and produces an undercooked egg of worse appearance.

Electronic controls allow for a more accurate (against the mapping or target cooking temperatures) designed cooking cycle and allows for one cooking utensil capable of multiple cooking cycles, i.e. large or small eggs, poach, fry, over easy, sunny up etc.

More sophisticated controls are described in a later patent. Our controls will tell the user when the egg is cooked or when to put the egg into the machine.

These improvements enable eggs to be cooked in reduced time with minimal electrical power consumption and the results can be replicated without specialist skills every time. Earlier patents have not recognised that the lid, if being of heat reflective material can be heated by the steam and this will help to cook the tops of the eggs.

They have not recognised that the time it takes to cook is important; our design will cook in 60 seconds so that eggs can be cooked “freshly” at the counter for customers.

Separate steam and egg zones allow for separate heating and multiple cook cycles and allows plates to be washed, have the egg loaded outside the machine and allow eggs to be served readily to the customers' plate.

None of the previous designs have integrated heating elements and controls that can “map” a designed cooking cycle and replicate a desired egg quality.

Energy consumption in a one minute pre-heat and one minute cook phase only uses about 20 seconds at 800 watts.

The electronic version can allow for a short pre heat and then various cook modes.

Steam injection—we have experimented with creating the steam in a separate vessel. This is technically more complicated, more expensive to build, would offer cleaning complications due to lime scale. Components would need to be kept warm in order to stop steam condensing. A large quantity of steam would need to be pumped—water expands by 1500 times when boiled. This solution offers no benefits.

This patent shows improvements to:

Heat up time of the plate.

Little energy used.

Cooking time of egg.

Repeatability of quality due to electrical controls.

By “mapping” the heat up and cool down characteristics of the plates so that electrical controls can act in an intelligent way during the cooking process. The subject and details of these controls form a future patent.

### Problems with Cited Patents

Cooking plates have a large mass—difficult to control.

They have no cooking cycle, the patents citing only get the plate temperature to a top limit.

Cooking plate mass large, slow to heat up, inefficient use of electricity.

Egg cooking area combined with where water is poured, or in such a way that eggs will mix with water during cooking—result is poor quality.

No integrated heater—contact poor, heating up slow and inefficient.

Can't monitor temperature of egg so next best thing is temperature of plate directly under egg.

Steam injection—U.S. Pat. No. 4,512,250 this has steam injection. Water expands 1500 times into steam. We use less than 1 cm cubed—this would mean pumping in 1500 cm cubed of steam. Steam would start to condense.

No Heat Controls

U.S. Pat. No. 2,517,167 lid is full of water so steam void will not heat up correctly—condensation will fall onto egg actual—cited in paragraph 15 column 2.

Simple heat control—No defined cooking cycle.

No user controls audio visual cooking. This leaves the quality of the egg down to the user.

Void large—minimise water

Void does not remain hot—water condenses.

U.S. Pat. No. 0,032,546—this only indicates pan temperature and has no integrated heater and therefore no control.

### INTRODUCTION TO DRAWINGS

A preferred embodiment of the invention will be described in conjunction with the drawings, which show: the egg and cooking zones, heaters, lid.

1 egg cooking zone

2 steam making zone

3 outer ridge or raised portion

4 inner ridge or raised portion

5 integrated heating element

6. bonded heating element

FIG. 1 Plan view of a plate containing one steam generation zone and one egg cooking zone, lid excluded for clarity.

FIG. 2. Plan view of one separate steam generation zone and one separate egg cooking zone. Lid excluded for clarity. The shape of the steam and egg zone are not restricted to the shape shown.

FIG. 3. Shows a section of a plate containing egg and steam zone heated with at least one integrated element. Lid shown with aid of outer ridges form steam void.

FIG. 4 shows a plate containing egg and steam zones heated with at least one thick film element or the like.

FIGS. 5 and 6 shows the lid and separate egg and steam areas each heated with elements or thick film or the like. At least one egg and one steam area has a lid.

FIG. 7 shows that with certain controls the areas can be heated with an electric hob or induction element or similar.

FIGS. 8 and 9 show that the egg and steam areas may be on different levels to aid water input for example injection under the cooking plate.

FIGS. 10, 11, 12 13 are graphs of temperature and time showing how the heat up curve. This can be controlled with the bi-metal switch and adjustments of plate mass, expected egg mass (and temp), the energy input and the switch off-on range.

For the electronic control, the energy input can be dynamic.

There is a measurable temperature drop after the egg is placed, this is used to reset the bimetal switch and further heat up the plate.

FIG. 10 shows a “quick cook” heat up curve or mapping when the egg is placed in the egg area during the pre-heat phase.

FIG. 11 shows a sample heat curve or mapping when a preheat temperature as been reached, then the egg placed and then the cook cycle.

FIG. 12 shows how the egg plate would be heated to pre-heat when using a bi-metal switch. The plate temperature would oscillate between the on and off positions waiting for input of the egg.

FIG. 13 shows how the curve in FIG. 12 can be manipulated by using electronic controls. Pre-heat curve is steeper so faster cooking, smoothing out the curve near the top temperature allows for a more accurate more accurate cook cycle—important when frying but not burning.

FIG. 14 shows that the egg and or steam area can be designed to be part of, or detachably attached to a base machine that would hold controls, switches etc.

FIG. 15 shows that the egg area may use a detachably attached plate which would enable easy cleaning or allow delivery to the eating plate.

FIG. 16 is a cross section of a cooking plate showing how eggs of different sizes will cook in the same place due to shape of the plate and large front radius which also helps when removing the egg from the plate.

FIG. 17 shows how the heat up curves can be under damped, over damped or critically damped.

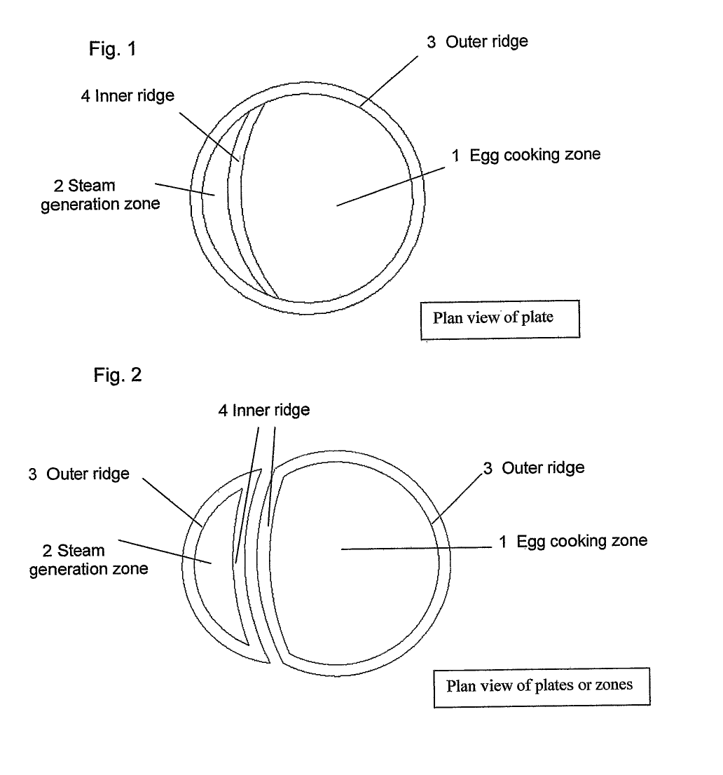

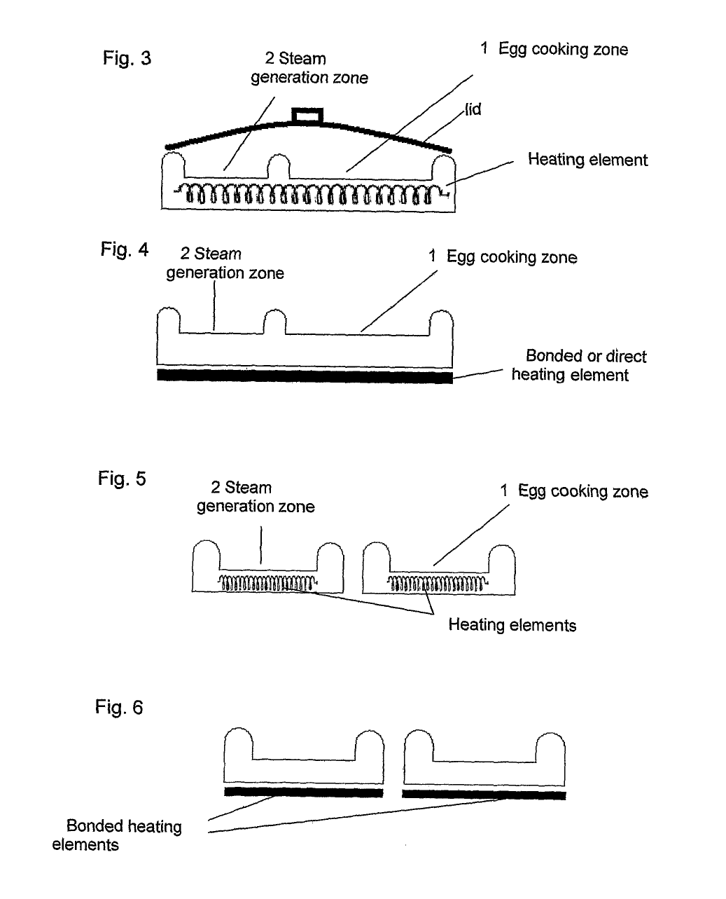

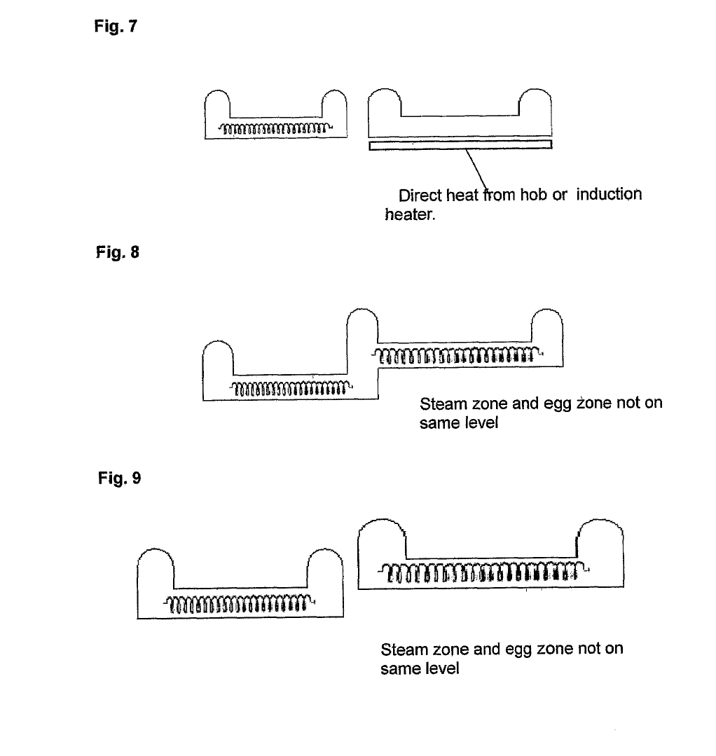

### DETAILED DESCRIPTION

The invention has separate egg cooking zones and steam generation zones in the form of “cooking plates”, which are controlled to heat up via direct heat such as but not limited to an integrated element or thick film element. It is also possible with certain controls to use an electric hob or induction element or loop. Simple controls such as bi-metal switches, thermistors or thermocouples allow heating up of the zones to be controlled at suitable temperatures to cook the egg from the bottom but also to generate steam.

An egg or eggs are places into the egg cooking zone or plate and a small quantity of water is placed into the steam making zone or plate. Co-ordination of the heating of the areas cooks the egg from below, and produces steam which heats up the area under the lid and the outer ridges of the plates or zones.

The invention relates to a utensil to cook “fried” eggs which programmes, controls and co-ordinates the variables in cooking the egg:

a. The surface area in contact with heat source, by having ridges or raised portions.

b. The speed that heat can be induced into the egg.

c. The time that the egg is cooked.

d. A method of cooking the top of the egg, in this case by cooking with steam where the amount of steam and co-ordination with the cook cycle can be controlled.

There are advantages in having the egg and steam areas together on one plate for cost benefits. This can consist of one plate, one switch (or control) and one heater.

However where one is cooking a large number of eggs, cleaning and service is important. In this case removable parts offer advantages. In this case the steam area and egg cooking area (which may or may not be adjoined) together with the lid behave in contiguous manner

Development of the heaters and their connectors offer some cleaning options. The parts can be washed in-situ, or removed to be cleaned by hand or in a dishwasher.

A close coupled lid, which enables the steam to remain for the cooking cycle encloses at least a steam zone and an egg zone so that a very small quantity of water expands into the void, heats up the lid and cooks the top of the egg. The steam zone also provides heat to keep the void hot. Keeping the void hot reduces the water needed, stops condensation, speeds up cooking, avoids oil spitting—all of which means that a cooking cycle can be controlled which in turn means consistently cooked eggs.

A simple set of user controls with visual and audible warnings in co-ordination with the heat sources and temperature switches/sensors allow one or more cooking programmes to be defined, for example slow poach, quick poach, fried etc. For example during a poach cycle no oil is used and a lower cooking temperature, whilst for frying a small quantity of oil is used together with a higher cook temperature. For a sunny egg no water is used with a lower temperature and longer duration. Over easy eggs can be produced by turning the egg and cooking on both sides.

The invention allows eggs to be cooked to an expected heat up curve in particular how it is damped. The energy input is balanced with the plate and egg mass and must be designed to allow a target cooking temperature and duration in order to replicate each cooking mode. The cooking mode is poach, fry, over easy, sunny side up or different sizes etc.

For a café version it is possible to use a lid that covers more than one steam zone and more than one egg zones or provide a larger egg zone so that 2 or more eggs can be cooked together.

Several “cooking plates” could be combined together for a “catering” appliance, each having shared or separate controls.

For optimum cooking quality (repeatability) one lid and control set per egg zone and steam zone is preferred but not essential.

The cooking cycle may be controlled to reach a “pre-heat” temperature, the egg is then placed into the cooking zone, water added to the steam zone, lid closed and the cook phase started. The placing of the egg onto the cooking plate causes a significant temperature drop on the plate. The plate regains heat and the heating elements are so designed that adequate heat is generated under the steam zone to produce steam. The cook phase allows a maximum cooking temperature or maximum cooking time to be reached. There may be audible and visual means of showing that the equipment is in standby mode, in pre-heat zone, has attained cook temperature, in cooking phase and finished.

Steam is generated above 100 deg C. Between 110 C. and about 140 degrees C. is the optimum temperature to poach an egg. Temperatures close to 160-180 deg C. can be used to fry the bottom of the egg.

By using separate plates and heaters in co-ordination it is possible to reduce the cooking cycle to a minimum time whilst maintaining egg quality and repeatability. For example to fry the bottom of the egg crisp requires a plate temperature about 180 degrees C. but this would boil water away too quickly. In a working situation cooking many eggs there may be a safety concern with hot steam. Co-ordination of both zones will remedy this.

It is possible to change the plate mass, input power and bi-metal switches to cook at different heat curves.

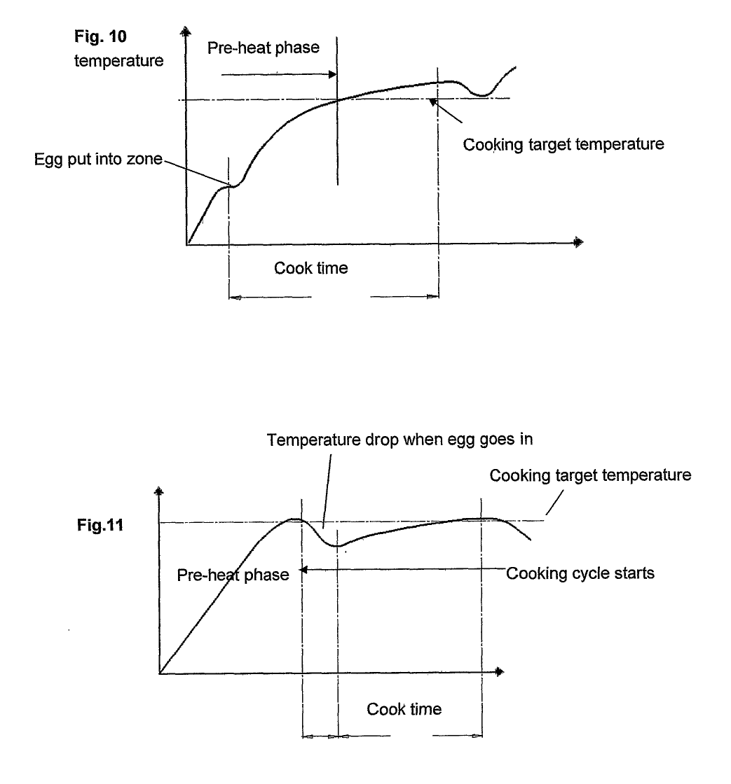

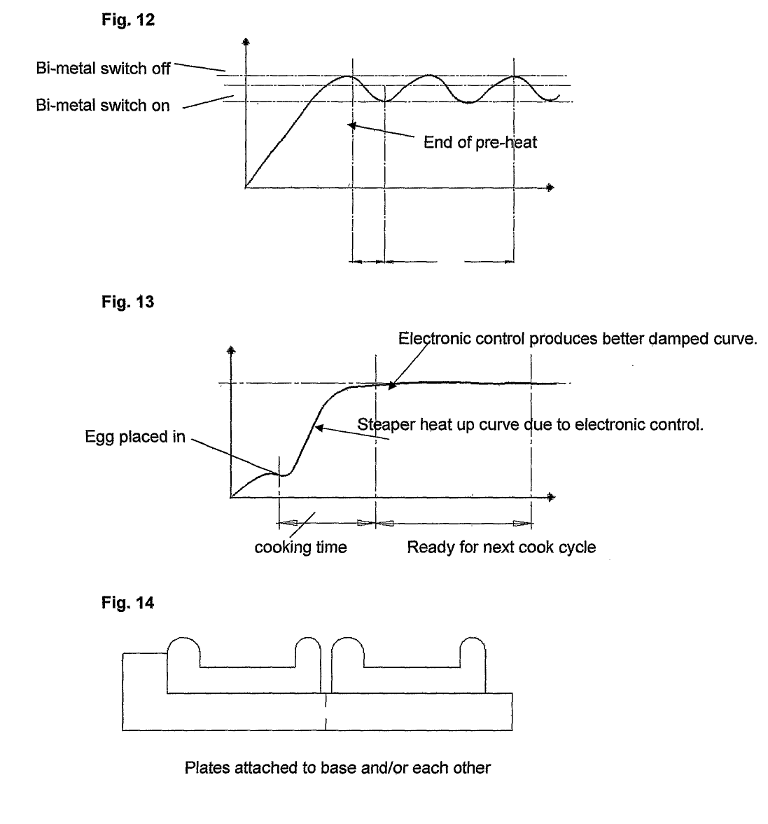

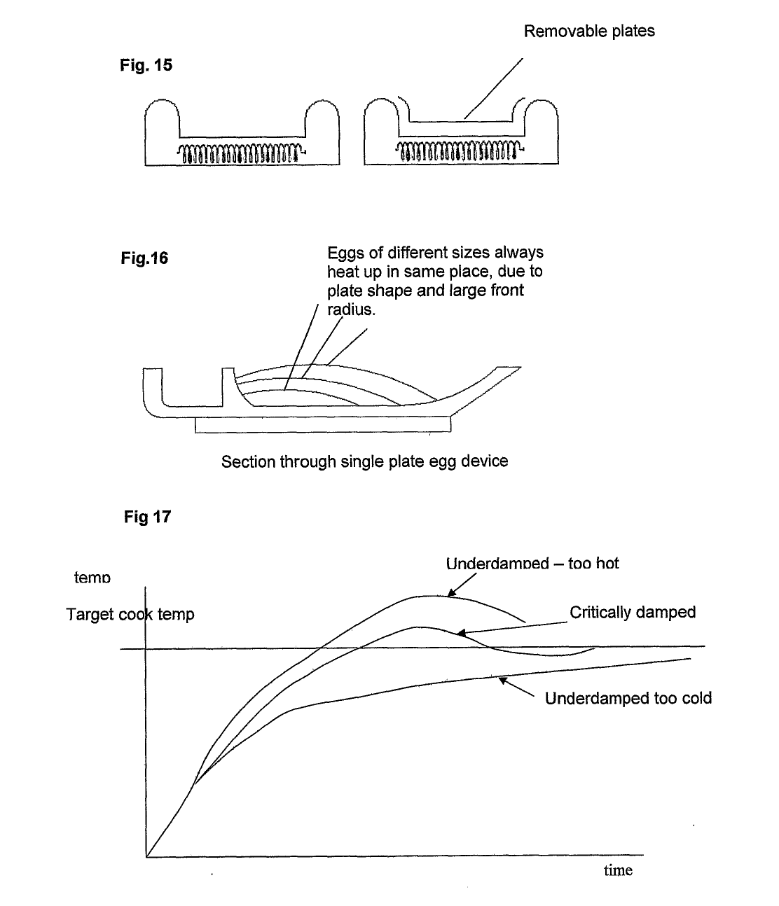

It is possible to design the unit to be switched on and then within a few seconds to load the egg. The heat input being designed for a specific cook duration and temperature switch off point see FIG. 10.

In all cases the power input (voltage×amperage) to the zones must be controlled for a designed heat up curve and a maximum temperature rise above the target cooking temperature.

It is possible to use more than one heat element in the egg zone and one or more bi-metal switches in order to construct a heat curve with different stop points and different heat input.

With the bi-metal switch control, the power input cannot be chanted during the cooking cycle. The bi-metal switch has a switch on and off temperature. The range of this, say on at 125 and off at 135 leaves a ten degree range. This range, together with the plate mass, energy input and more particularly the location of the bi-metal controls (because the plates do not heat up uniformly) the heat up curve and the mode of cooking of the egg. The control would include a mechanical power off switch similar to a kettle control. It would be possible to use an adjustable bi-metal switch to allow for a change in the off or on point.

With electronic controls a thermistor or thermocouple or similar is used to monitor plate temperature under the egg, this is used by the control system to regulate the input power to one or both zones. The control system can be designed to perform more than one defined cooking mode or cycle.

To enable washing of the cooking parts or removal of the egg to the plate, the steam or egg zones may be detachably attached from each other or the heated bases. In this case the electrical power may be connected through the base, adjoined parts or the handle. This would require the heating elements themselves to be detachable.

The egg cooking plate is so designed to allow for easy removal of the egg from the front with a thin spatula, the front plate radius being large and smooth.

The plates may be non-stick coated. Some non-stick coatings make water globulate when boiling. Different non-stick coatings can be used for the steam and egg zones, a textured surface can provide a greater surface area in the steam zone to aid boiling.

Modern plastics capable of high temperatures may be used for some parts.

Water is added to the steam zone by the user with a spoon or dedicated measuring device. It can be added automatically by injection or dropping and this can be coordinated with the heat input. The water can be added through the lid, base, handle. The raising or lowering of the lid may effect the deposition of the correct amount of water into the device. Other ways not limiting are:
a. the lid can contain a small cup, water can be added and when the lid is lowered the water is poured onto the heated plate.
b. The lid can be connected to a small water hopper with a pipe. The pipe will be connected to a cylinder and piston (like a spray bottle), when the lid is raised it will draw a small amount of water into it, when lowered it will squirt atomised water onto the heated plate—this will aid boiling and stop globulisation.
c. There could be a small vessel above the lid or on the lid with a plunger and valve, pressing the plunger could allow a small quantity of water to drop onto the heat zone.

Addition Features

Any number of sets of ridges could be formed within one plate. Any number of plates containing one set of ridges could form a cooking appliance each with separate lids. The lids and base may be hinged together.

The lid may be shaped to affect the flow of steam around the cooking eggs.

The “plate” may have a contoured underside in order to fit into the base unit's heating element to make good contact with said for good heat transfer. The cooking plate and base may have steam ducts in order that steam can be forced down them to help speed up the heating of the cooking plate.

The lid can be controlled to lift after a set period of time.

The cooking plate can be controlled to lift away from the base heat source in order to slow the cooking after a set period has elapsed.

The heated base may be switched on when the cooking plate is fitted onto it by integral switches. There will be over heat controls also. If the steam making portion is separate this too can be heated from the base when it is located onto the base

The steam may be generated in a zone not on the same level as the egg cooking area, so that water can be put into it when the lid is closed or injected from a water reservoir.

The large inner radii of the outer ridge allows the user to easily slide the egg out of the cooking area by simply tilting it without using other utensils. The egg plate can be so designed that eggs of different sizes slip back to its base and cook in the same area.

There can be audible and visual means of showing the user when the base or plate are hot enough and when the egg is cooked or a timer has elapsed or any other cooking characteristic. An led or LCD or similar screen can be used for showing the user cooking variables or characteristics.

The lid may be connected to the base unit, the lid being controlled to open after a timer has elapsed.

The egg cook zone and steam zones may be designed with different thickness in order to heat up at different speeds.

The outer raised portion may house a lip for the lid, this lip not being continuous, or the outer ridge having a portion of reduced height that allows steam to escape.

Where a separate heat source is used, such as with a hob, the base may be contoured to provide a good contact surface or to keep the plate from slipping off the base unit.

The heating elements may be so designed that areas of each plate may heat up at different rates or to different temperatures.

The lid may be raised after a timer has elapsed in order to slow the cooking down at the end of the defined cooking period.

This invention offers several advantages.

Uses less energy—only about 20 seconds of power on the quick cook cycle.

Quicker eggs can be cooked in 60 seconds.

more consistent

Repeatable cooking quality

Fries or poaches—multi programmes.

Needs no special knowledge.

Easy to get the cooked egg out.

Easy to clean

Uses non stick coatings so that oil is not used

More healthy

Small footprint for placement on countertops.

Can make allowances for human error.

Multi-mode cooking each subsequently cooked egg can be cooked differently.

1-8. (canceled)

9. An egg cooking appliance comprising:
at least one plate having an upper surface or surfaces defining at least a first recess for receipt of a de-shelled egg constituting an egg cooking zone, and a second recess for receipt of a quantity of water constituting a steam generating zone and
at least one temperature sensing element responsive to plate temperature under the egg.

10. An egg cooking appliance according to claim 9 with an electrical heater for heating said plate or plates

11. An egg cooking appliance according to claim 9 with a lid which in use covers said first and said second recesses.

12. An egg cooking appliance according to claim 9 wherein said temperature sensing element is selected from a bimetallic switch that is adjustable, and a bimetallic switch that is non adjustable.

13. An egg cooking appliance according to claim 10 including electronic controls, and wherein said temperature sensitive element is an electronic component which indicates the plate temperature to said controls.

14. An egg cooking appliance according to claim 13 wherein said temperature sensitive element is selected from a thermistor and a thermocouple.

15. An egg cooking appliance according to claim 13 wherein said electronic controls can perform more than one defined cooking mode or cycle selected or set by the user.

16. An egg cooking appliance according to claim 13 including a notification element adapted to show some or all of the following:
stand-by mode, pre-heat phase, has attained cook temperature, cooking phase, and has finished, programme or cook mode, cooking variables, cooking characteristics.

17. An egg cooking appliance according to claim 13 in which said electronic controls are adapted to control the plate temperature to follow a predefined cooking curve.

18. An egg cooking appliance according to claim 13, in which the cooking curve includes a pre-heat phase during which said cooking plates are heating up, and a cooking phase at or near a desired cooking temperature.

19. An egg cooking appliance according to claim 2 or 5 wherein a control reacts to the plate temperature, and is adapted to, in accordance with the programme selected by the user, dynamically control the heat up curve, after insertion of an egg and reacting to the temperature drop of said plate.

20. An egg cooking appliance according to claim 10 wherein said heater is provided directly on or in the plate or plates.

21. An egg cooking appliance according to claim 2 wherein said electrical heater is arranged in or on a heating base unit, said plate or plates being in thermal contact with said heating base unit.

22. An egg cooking appliance according to claim 21 wherein said plate or plates are detachable from said heating base unit.

23. An egg cooking appliance according to claim 13 wherein said plate or plates are detachable from said electronic controls.

24 An egg cooking appliance according to claim 9 wherein said plate or plates are detachably attached to a heat source.

25. An egg cooking appliance according to claim 9 wherein the appliance comprises a unitary plate having a peripheral lip and an internal ridge or partition extending across the plate to define a relatively larger egg cooking zone and a relatively smaller steam generating zone.

26. An egg cooking appliance according to claim 9 wherein the appliance comprises separate plates or recesses respectively defining the egg cooking zone and steam generating zone.

27. An egg cooking appliance according to claim 9 wherein said egg cooking zone recess is adapted so that eggs of different sizes or masses are cooked in the same relative place in the plate and with a large smooth front radius.

28 An egg cooking appliance according to claim 12 in which said temperature sensing element is a bimetallic switch which is adjustable.
